(19) United States
(12) Patent Application Publication
(10) Pub. No.: US 2012/0116663 A1
(43) Pub. Date: May 10, 2012

(54) OBSTACLE DETECTION DEVICE AND OBSTACLE DETECTION SYSTEM

(75) Inventor: Jun Tsunekawa, Aichi-ken (JP)

(73) Assignee: TOYOTA JIDOSHA KABUSHIKI KAISHA, AICHI-KEN (JP)

(21) Appl. No.: 12/995,884

(22) PCT Filed: Apr. 15, 2009
(86) PCT No.: PCT/IB09/05238

§ 371 Date: Dec. 2, 2010

(30) Foreign Application Priority Data
Jun. 5, 2008 (JP) 2008-148296

(51) Int. Cl. G06F 17/00

(52) U.S. Cl. 701/300

(57) ABSTRACT

Objects relatively approaching a vehicle diagonally are detected, and at least relative distances of the detected objects with respect to the vehicle and relative speeds of the detected objects with respect to the vehicle are calculated. Using the relative distances of the objects and the relative speeds of the objects, estimated collision time lengths to collisions of the objects with the vehicle are calculated respectively. A predetermined number of the objects that are arranged in an ascending order of the estimated collision time lengths are selected, and pieces of detected information on the selected objects are output.

### BACKGROUND OF THE INVENTION

1. Field of the Invention

The invention relates to an obstacle detection device and an obstacle detection system, and more specifically, to an obstacle detection device and an obstacle detection system that detect other objects located around a vehicle.

2. Description of the Related Art

As a related art, a vehicle is mounted with a radar device for capturing targets located around the vehicle, such other vehicles and the like (e.g., see Japanese Patent Application Publication No. 2001-126194 (JP-A-2001-126194). An obstacle detection device for a vehicle disclosed in Japanese Patent Application Publication No. 2001-126194 (JP-A-2001-126194) calculates a position of an obstacle, a relative speed of the vehicle with respect to the obstacle, an estimated time of a collision of the vehicle with the obstacle, in accordance with a detection result obtained by radar. The aforementioned obstacle detection device for the vehicle estimates a risk of a collision between the own vehicle and the obstacle on the basis of a result of the aforementioned calculation.

Now, considering a configuration in which target information captured by radar is transmitted from the radar device to another device, the number of transmitted targets in the target information transmitted from the radar device needs to be limited due to a restriction on a communication bus load between the devices. However, in the case where there are a plurality of obstacles around the vehicle at the same time, if the obstacle detection device for the vehicle disclosed in Japanese Patent Application Publication No. 2001-126194 (JP-A-2001-126194) comprehensively makes determinations on positions of the obstacles, speeds of the vehicle relative to the obstacles, and estimated time lengths of collisions of the vehicle with the obstacles, increases in calculation load and communication load are caused.

Further, it is conceivable to narrow down pieces of target information transmitted from the radar device, for example, in the order of reflection intensities obtained by detecting reflected waves of targets, in the ascending order of distances to the targets on an own lane where the own vehicle runs, or in the ascending order of estimated time lengths of collisions of the vehicle with the targets on the own lane. However, in the case where the radar device is mounted with the radiation direction coincident with a direction diagonally forward with respect to the vehicle, it may be impossible through those narrowing-down methods to make appropriate determinations on risks of collisions of the vehicle with the obstacles.

For example, in the case where the targets in the pieces of target information transmitted in the aforementioned order of the reflection intensities are narrowed down, the reflection intensity of a road-side object such as a guardrail, a building, or the like may be higher than the reflection intensity of a target vehicle desirable as a detection objective. In this case, it is impossible to appropriately narrow down the targets. Further, in the case where the radar device is mounted with the radiation direction thereof coincident with the direction diagonally forward with respect to the vehicle, vehicles approaching the own vehicle at a slant or head-on are defined as target vehicles. However, since these target vehicles do not exist on the aforementioned own lane, the aforementioned method of narrowing down the target vehicles in the order of distances or estimated collision time lengths is useless.

### SUMMARY OF THE INVENTION

The invention provides an obstacle detection device and an obstacle detection system that can achieve a reduction in calculation load or communication load through the selection of targets whose risks of collisions with an own vehicle can be appropriately determined.

A first aspect of the invention relates to an obstacle detection device equipped with a detection portion, a relative distance/relative speed calculation portion, an estimated collision time length calculation length, an object selection portion, and an information output portion. The detection portion detects objects relatively approaching a vehicle. The relative distance/relative speed calculation portion calculates at least relative distances of the objects detected by the detection portion with respect to the vehicle and relative speeds of the objects detected by the detection portion with respect to the vehicle. The estimated collision time length calculation portion calculates estimated collision time lengths to collisions of the objects with the vehicle, using the relative distances of the objects and the relative speeds of the objects respectively. The object selection portion selects a predetermined number of the objects that are arranged in an ascending order of the estimated collision time lengths as selected objects. The information output portion outputs pieces of detected information on the selected objects.

According to the aforementioned configuration, it is possible to narrow down output subjects whose pieces of detected information are to be output, in the ascending order of the estimated collision time lengths calculated from the relative speeds and relative distances of the objects approaching the own vehicle diagonally. Therefore, reductions in calculation load and communication load can be achieved in an entire system.

The obstacle detection device according to this aspect of the invention may further be equipped with a selected object change portion. The selected object change portion may replace, when the object having a shorter relative distance than that one of the objects selected by the object selection portion which has a predetermined rank in an ascending order of the estimated collision time lengths belongs to the detected objects except the selected objects, the object having the shorter relative distance and one of the objects selected by the object selection portion with each other to change the selected objects.

According to the aforementioned configuration, in the case where even an object having a relatively long estimated collision time length requires a priority processing because of a short relative distance, information on the object can be output by priority. As a result, it is possible to make an appropriate determination on a risk of a collision of the object with the own vehicle or the like in a device at a subsequent stage.

In the obstacle detection device according to this aspect of the invention, the object replaced with the object having the shorter relative distance by the selected object change portion may be that one of the objects selected by the object selection portion which has a predetermined rank.

According to the aforementioned configuration, in the case where even an object having a relatively long estimated collision time length requires a priority processing because of a short relative distance, it is possible to replace the object with the object having the predetermined rank and output information on the object by priority. As a result, it is possible to make an appropriate determination on a risk of a collision of the object with the own vehicle or the like in a device at a subsequent stage.

In the obstacle detection device according to this aspect of the invention, the object replaced with the object having the shorter relative distance by the selected object change portion may be that one of the objects selected by the object selection portion which has a longest estimated collision time length.

According to the aforementioned configuration, in the case where even an object having a relatively long estimated collision time length requires a priority processing because of a short relative distance, it is possible to replace the object with that one of the already selected objects which has a lowest priority rank due to the longest estimated collision time length, and output information on the object by priority. As a result, it is possible to make an appropriate determination on a risk of a collision of the object with the own vehicle or the like in a device at a subsequent stage.

In the obstacle detection device according to this aspect of the invention, the selected object change portion may replace, when the object having the shorter relative distance is shorter in relative distance than that one of the objects selected by the object selection portion which has a longest estimated collision time length, the object having the shorter relative distance and that one of the objects selected by the object selection portion which has the longest estimated collision time length with each other to change the selected objects.

According to the aforementioned configuration, in the case where even an object having a longer estimated collision time length than that one of the already selected objects which has a lowest priority rank requires a priority processing because of a short relative distance, it is possible to replace the object with the object having the lowest priority rank and output information on the object by priority. As a result, it is possible to make an appropriate determination on a risk of a collision of the object with the own vehicle or the like in a device at a subsequent stage.

In the obstacle detection device according to this aspect of the invention, the selected object change portion may further replace, when the object having a shorter relative distance than that one of the objects selected by the object selection portion which has the second longest estimated collision time length belongs to the detected objects except the selected objects and the replaced object, the object having the shorter relative distance and that one of the objects selected by the object selection portion which has the second longest estimated collision time length with each other to change the selected objects.

According to the aforementioned configuration, in the case where even an object having a longer estimated collision time length than that one of the already selected objects which has the second lowest priority rank requires a priority processing because of a short relative distance, it is possible to replace the object with the object having the second lowest priority rank and output information on the object by priority. As a result, it is possible to make an appropriate determination on a risk of a collision of the object with the own vehicle or the like in a device at a subsequent stage.

In the obstacle detection device according to this aspect of the invention, the object selection portion may generate a list in which pieces of information on the objects are described in arrangement in the ascending order of the estimated collision time lengths. The selected object change portion may replace description ranks of pieces of information on the objects in the list to change the selected objects. The information output portion may output pieces of information on a predetermined number of the objects described in the list in a descending order from a highest rank.

According to the aforementioned configuration, it is possible to easily adjust the priority ranks by using the list in which the pieces of information on the objects are described in the order of the priority of the processing.

In the obstacle detection device according to this aspect of the invention, the number of the objects selected by the object selection portion may be set on a basis of a communication bus load output from the information output portion to another device.

According to the aforementioned configuration, it is possible to output information in consideration of the communication bus load output from the obstacle detection device.

In the obstacle detection device according to this aspect of the invention, the estimated collision time length calculation portion may divide the relative distances of the objects by the relative speeds thereof to calculate the estimated collision time lengths of the objects respectively.

According to the aforementioned configuration, it is easy to calculate the estimated collision time lengths, and the processing load in the obstacle detection device is reduced.

In the obstacle detection device according to this aspect of the invention, the objects detected by the detection portion may be objects relatively approaching the vehicle diagonally thereto.

A second aspect of the invention relates to an obstacle detection system equipped with a plurality of detection devices and an object selection device. The plurality of the detection devices detect objects relatively approaching a vehicle respectively. The object selection device selects a predetermined number of the objects from the objects detected by the plurality of the detection devices respectively. The plurality of the detection devices calculate at least relative distances of the detected objects with respect to the vehicle and relative speeds of the detected objects with respect to the vehicle and output the relative distances and the relative speeds to the object selection device. The object selection device includes an acquisition portion, an estimated collision time length calculation portion, and an object selection portion. The acquisition portion acquires the relative distances output from the plurality of the detection devices respectively and the relative speeds output from the plurality of the detection devices respectively. The estimated collision time length calculation portion calculates estimated collision time lengths to collisions of the objects with the vehicle respectively, using the relative distances of the objects acquired by the acquisition portion and the relative speeds of the objects acquired by the acquisition portion. The object selection portion selects a predetermined number of the objects in an ascending order of the estimated collision time lengths.

According to the aforementioned configuration, it is possible to narrow down the objects in the ascending order of the estimated collision time lengths calculated from the relative speeds of the objects and the relative distances of the objects, for pieces of information on the objects detected by the plurality of the detection devices respectively. Therefore, the calculation load in the entire system can be reduced.

In the obstacle detection system according to this aspect of the invention, at least one of the plurality of the detection devices may detect objects approaching the vehicle from spots diagonally forward and rightward thereof, and at least another one of the plurality of the detection devices may detect objects approaching the vehicle from spots diagonally forward and leftward thereof.

A third aspect of the invention relates to an obstacle detection method including detecting objects relatively approaching a vehicle, calculating relative distances of the detected objects with respect to the vehicle and relative speeds of the detected objects with respect to the vehicle, calculating estimated collision time lengths to collisions of the objects with the vehicle using the calculated relative distances of the objects and the calculated relative speeds of the objects respectively, selecting a predetermined number of the objects that are arranged in an ascending order of the estimated collision time lengths, and outputting pieces of detected information on the selected objects.

The obstacle detection method according to this aspect of the invention may further include outputting, when the object having a shorter relative distance than that one of the predetermined number of the objects which has a predetermined rank in the ascending order of the estimated collision time lengths belongs to the detected objects except the predetermined number of the objects, detected information on the object having the shorter relative distance instead of detected information on the object having the predetermined rank.

### BRIEF DESCRIPTION OF THE DRAWINGS

The foregoing and further objects, features and advantages of the invention will become apparent from the following detailed description of an example embodiment with reference to the accompanying drawings, wherein like numerals are used to represent like elements and wherein:

FIG. 1 is a block diagram showing an example of a functional configuration of a driver support system including an obstacle detection device according to one embodiment of the invention;

FIG. 2 is a block diagram showing an example of a functional configuration of a radar device 1 of FIG. 1;

FIG. 3 is a diagram showing an example of main data stored in a memory of a target processing portion 13 of FIG. 2;

FIG. 4 is a flowchart showing an example of a processing performed by the target processing portion 13 of FIG. 2;

FIG. 5 is a diagram showing an example of how the target processing portion 13 of FIG. 2 creates a target list and permutates the contents thereof;

FIG. 6 is a diagram showing an example of a situation of target objects in front of an own vehicle;

FIG. 7 is a diagram showing an example of a detection situation of target objects sensed in front of the own vehicle;

FIG. 8 is a diagram for explaining a first situation example at an intersection; and

FIG. 9 is a diagram for explaining a second situation example at an intersection.

### DETAILED DESCRIPTION OF EMBODIMENT

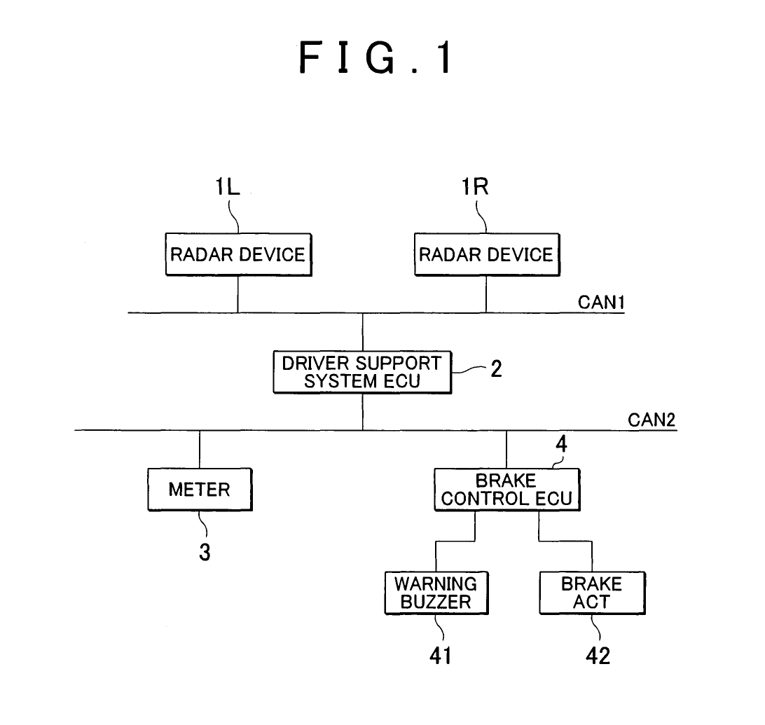

An obstacle detection device according to one embodiment of the invention will be described hereinafter with reference to FIG. 1. In this embodiment of the invention, an example in which a driver support system including the obstacle detection device is mounted on a vehicle will be described. As an example, the driver support system recognizes other vehicles and obstacles around the vehicle and makes a determination on a risk of collisions, on the basis of target information detected by the obstacle detection device, and performs the control of the vehicle corresponding to a result of the determination. FIG. 1 is a block diagram showing an example of a functional configuration of the driver support system including the obstacle detection device.

In FIG. 1, the driver support system is equipped with a radar device 1L, a radar device 1R, a driver support system electronic control unit (ECU) 2, a meter 3, a brake control ECU 4, a warning buzzer 41, and a brake actuator (ACT) 42. The radar device 1L, the radar device 1R, and the driver support system ECU 2 are connected to one another via a controller area network (CAN) 1 or the like. Further, the driver support system ECU 2, the meter 3, and the brake control ECU 4 are connected to one another via a CAN 2 or the like.

The radar device 1L emits, for example, millimeter waves diagonally leftward and forward of the vehicle, and receives electric waves reflected from targets (target objects) located diagonally leftward and forward of the vehicle. Further, the radar device 1R emits, for example, millimeter waves diagonally rightward and forward of the vehicle, and receives electric waves reflected from targets (target objects) located diagonally rightward and forward of the vehicle. Typically, the detection ranges of the radar device 1L and the radar device 1R are so set as to sense targets diagonally approaching the own vehicle (more specifically, targets approaching the own vehicle from outside an own lane where the own vehicle runs). Then, on the basis of electric waves received respectively, the radar device 1L and the radar device 1R calculate positions of other vehicles and obstacles (targets) located around the vehicle, relative speeds thereof with respect to the own vehicle, and the like, and output results of the calculation (target information) to the driver support system ECU 2 respectively via the CAN 2.

The radar device 1L and the radar device 1R are not limited to millimeter wave radars, and may be means for measuring positions of other vehicles and obstacles located diagonally forward of the vehicle, relative speeds thereof with respect thereto, and the like with the aid of other radar sensors, acoustic sensors, cameras, and the like. The radar 1L and the radar device 1R are identical in configuration to each other except in radiation direction. Therefore, the radar device 1L and the radar device 1R will be generically described as a radar device 1 when necessary. Further, each of the radar device 1L and the radar device 1R is equivalent to the obstacle detection device according to the invention.

The driver support system ECU 2 suitably adjusts the characteristics of passenger protection devices mounted on the vehicle, activates a collision condition alleviation system, or issues an appropriate warning to a driver, on the basis of pieces of target information output from the radar device 1L and the radar device 1R. In FIG. 1, the meter 3 and the brake control ECU 4 are illustrated as examples of devices controlled by the driver support system ECU 2.

The meter 3 is provided at a position visually recognizable from the driver, who sits in a driver's seat of the vehicle to drive the vehicle. For example, the meter 3 is provided on a dashboard (instrument panel) in front of the driver's seat, and displays to the driver a warning corresponding to a command from the driver support system ECU 2. For example, when there is a risk of a collision between the vehicle and a target, the driver support system ECU 2 causes the meter 3 to give an indication urging the driver to perform a collision avoidance operation. Typically, the meter 3 is configured as a combination meter having a single panel in which some main measuring gauges, an indication lamp, a warning lamp, a multi information display for displaying various pieces of information, and the like are arranged in combination. The meter 3 may be configured as another display device, for example, a head-up display (hereinafter referred to as a HUD) that fluorescently displays a virtual image of information or the like on a half mirror (reflecting glass) provided on part of a windshield in front of the driver's seat.

The brake control ECU 4 controls the operations of the warning buzzer 41 and the brake ACT 42, which are mounted on the vehicle. For example, when the driver support system ECU 2 determines that there is a risk of a collision between the vehicle and a target, the brake control ECU 4 activates the warning buzzer 41 to urge the driver to perform the collision avoidance operation. Thus, the driver can perform the collision avoidance operation. Further, the brake control ECU 4 performs the control of the operation of the brake ACT 42 or the like such that a brake hydraulic pressure is increased and assisted in accordance with a force with which the driver depresses a brake pedal. Thus, the hydraulic pressure responsiveness of the brake ACT 42 is improved, and it is possible to reduce the speed of the vehicle.

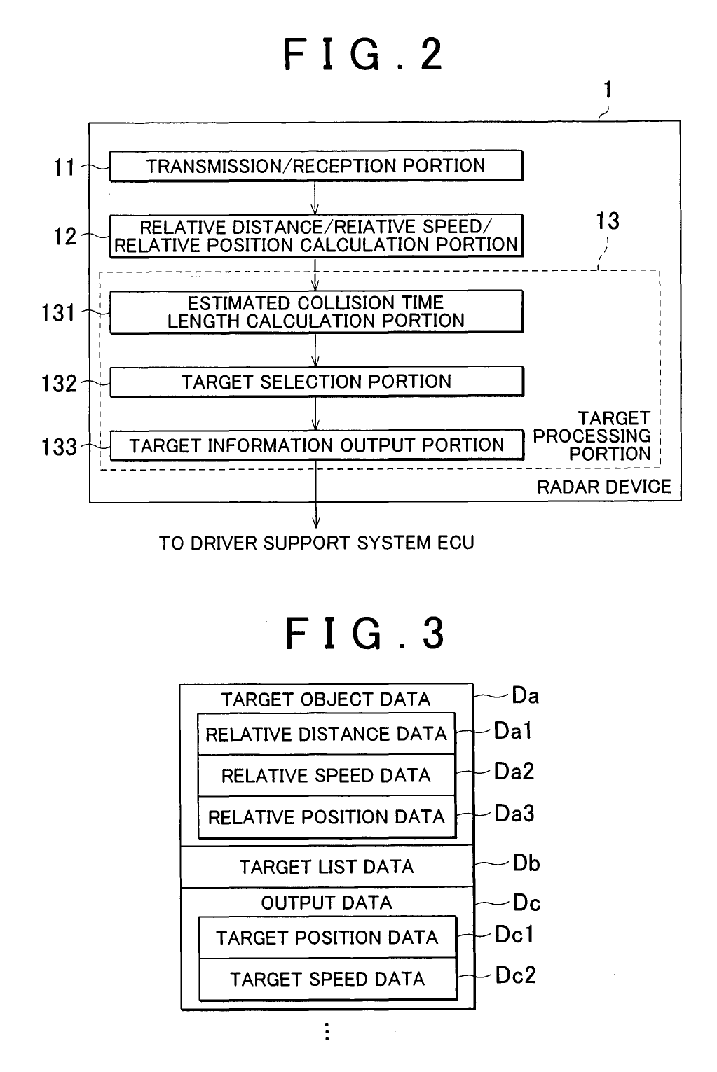

Next, the configuration of the radar device 1 will be described with reference to FIG. 2. FIG. 2 is a block diagram showing an example of a functional configuration of the radar device 1.

In FIG. 2, the radar device 1 is equipped with a transmission/reception portion 11, a relative distance/relative speed/relative position calculation portion 12, and a target processing portion 13. The target processing portion 13 is configured as, for example, a microcomputer having a storage device such as a memory or the like, and is equipped with an estimated collision time length calculation portion 131, a target selection portion 132, and a target information output portion 133 as functional components thereof.

The transmission/reception portion 11 emits, for example, millimeter waves, and receives reflected waves thereof. The transmission/reception portion 11 is provided at a predetermined position of a front-right portion of the vehicle or a front-left portion of the vehicle, and senses target objects located diagonally forward of the vehicle, such as other vehicles and the like. The transmission/reception portion 11 then outputs signals indicating the sensed target objects to the relative distance/relative speed/relative position calculation portion 12. The transmission/reception portion 11 outputs the signals for the sensed target objects individually.

The relative distance/relative speed/relative position calculation portion 12 calculates a relative distance of a target object with respect to the own vehicle, a relative speed of the target object with respect to the own vehicle, and a relative position of the target object with respect to the own vehicle as pieces of information on the target object (target information), using the signals acquired from the transmission/reception portion 11. For example, the relative distance/relative speed/relative position calculation portion 12 calculates the relative distance of the target object, the relative speed thereof, and the relative position thereof, using sums of the emitted millimeter waves and the received reflected waves, differences therebetween, transmission/reception timings thereof, and the like. In the case where the transmission/reception portion 11 senses a plurality of target objects, the relative distance/relative speed/relative position calculation portion 12 calculates relative distances, relative speeds, and relative positions for the target objects respectively. The relative distance/relative speed/relative position calculation portion 12 then supplies the estimated collision time length calculation portion 131 with data indicating the relative distances of the target objects, the relative speeds thereof, and the relative positions thereof (target information). The transmission/reception portion 11 and the relative distance/relative speed/relative position calculation portion 12 are configured to be able to detect pieces of target information on at most m (e.g., 20) target objects.

The estimated collision time length calculation portion 131 stores into the storage device the pieces of the target information acquired from the relative distance/relative speed/relative position calculation portion 12, and calculates estimated collision time lengths (TTC) to collisions of the target objects with the own vehicle individually for the target objects, using the pieces of the target information. For example, an estimated collision time length is calculated by dividing a relative distance calculated for a target object by a relative speed, namely, according to a formula: TTC=relative distance/relative speed. The estimated collision time length calculation portion 131 stores into the storage device data indicating the respective estimated collision time lengths of the target objects, and supplies the target selection portion 132 with the data. The estimated collision time length calculation portion 131 stores into the storage device the data in the form of a list (target list) in which the target objects are described in arrangement in the ascending order of the calculated estimated collision time lengths. Detailed operation of the estimated collision time length calculation portion 131 will be described later.

The target selection portion 132 makes a determination on the ranks of the target objects described in the target list and permutates the target objects, on the basis of the estimated collision time lengths and the relative distances, which have been calculated for the target objects individually. The target selection portion 132 then selects those of the target objects which have the first to n-th ranks in the target list, and outputs to the target information output portion 133 pieces of information indicating the relative positions of the respective target objects and the relative speeds thereof (target information).

The target information output portion 133 outputs the pieces of target information for the respective target objects, which have been acquired from the target selection portion 132, to the driver support system ECU 2 via the CAN 1.

Next, the main data used in the target processing portion 13 will be described with reference to FIG. 3 before describing the concrete operation of the target processing portion 13. FIG. 3 is a diagram showing an example of the main data stored in the memory of the target processing portion 13.

In FIG. 3, target object data Da, target list data Db, output data Dc, and the like are stored in the storage device of the target processing portion 13.

The target object data Da include, as target information, relative distance data Da1, relative speed data Da2, and relative position data Da3. The relative distance data Da1, namely, the data indicating the relative distances of the target objects with respect to the own vehicle, which have been acquired from the relative distance/relative speed/relative position calculation portion 12, are stored for the target objects individually. The relative speed data Da2, namely, the data indicating the relative speeds of the target objects with respect to the own vehicle, which have been acquired from the relative distance/relative speed/relative position calculation portion 12, are stored for the target objects individually. The relative position data Da3, namely, the data indicating the relative positions of the target objects with respect to the own vehicle, which have been acquired from the relative distance/relative speed/relative position calculation portion 12, are stored for the target objects individually.

The target list data Db, namely, the data indicating the target list which has been created by the estimated collision time length calculation portion 131 and whose contents have been permutated by the target selection portion 132 are stored. For example, the estimated collision time length calculation portion 131 arranges pairs of the estimated collision time lengths (TTC) of the target objects and the relative distances of the target objects in the ascending order of the estimated collision time lengths, and assigns target numbers to the pairs respectively to create the target list. The target selection portion 132 then makes a determination based on relative distance on the target objects having the target numbers satisfying a predetermined condition, and permutates the contents of the target list.

The output data Dc, namely, the data indicating the pieces of target information to be output to the driver support system ECU 2 by the target information output portion 133 are stored. For example, in the case where the relative positions of the target objects and the relative speeds thereof are included as the pieces of the target information to be output, the output data Dc include data indicating the relative positions of the respective selected target objects (target position data Dc1) and data indicating the relative speeds of the respective selected target objects (target speed data Dc2).

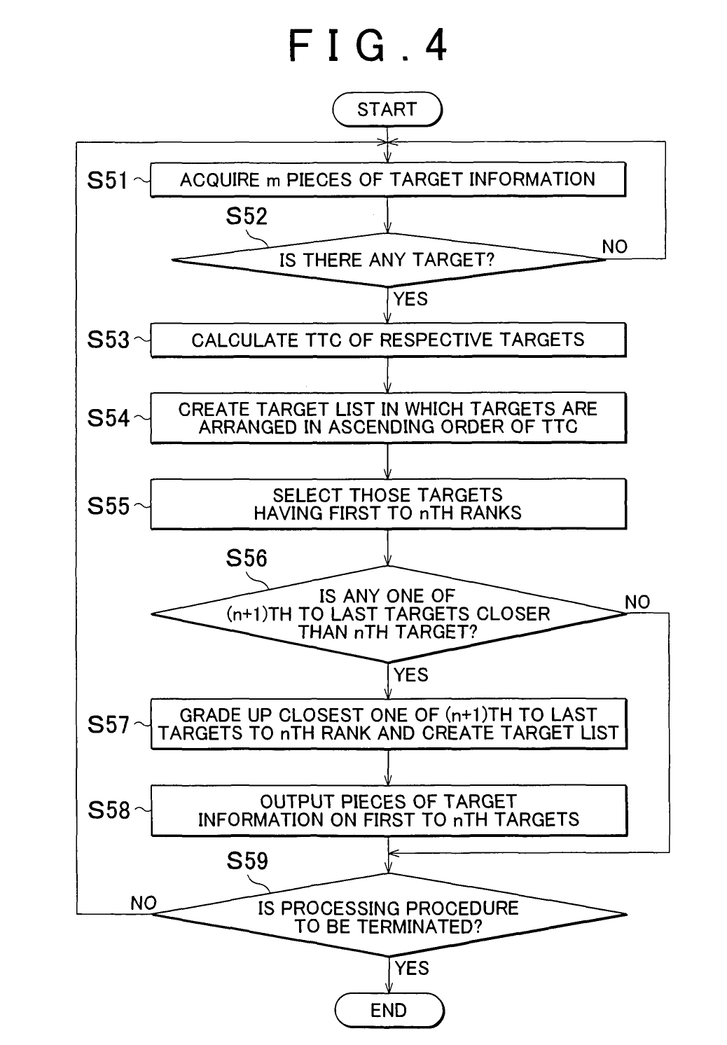

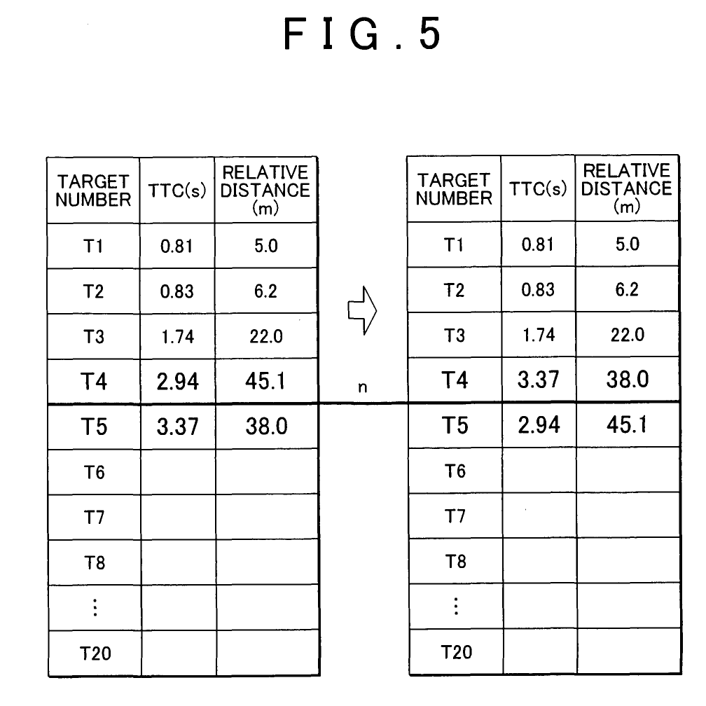

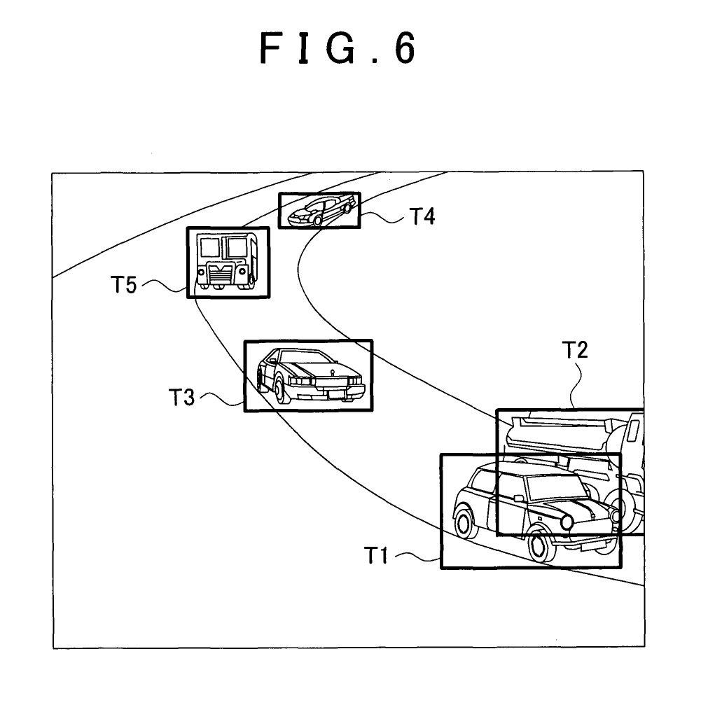

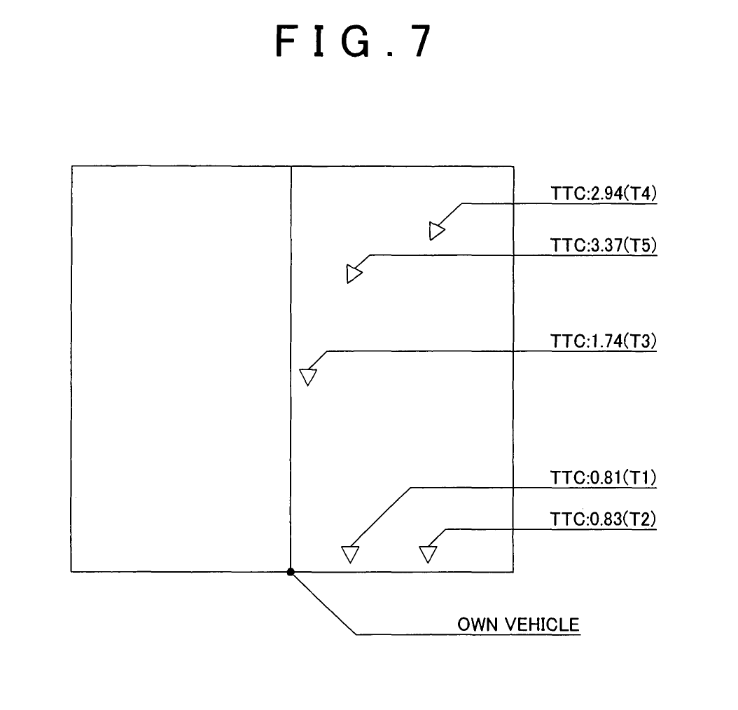

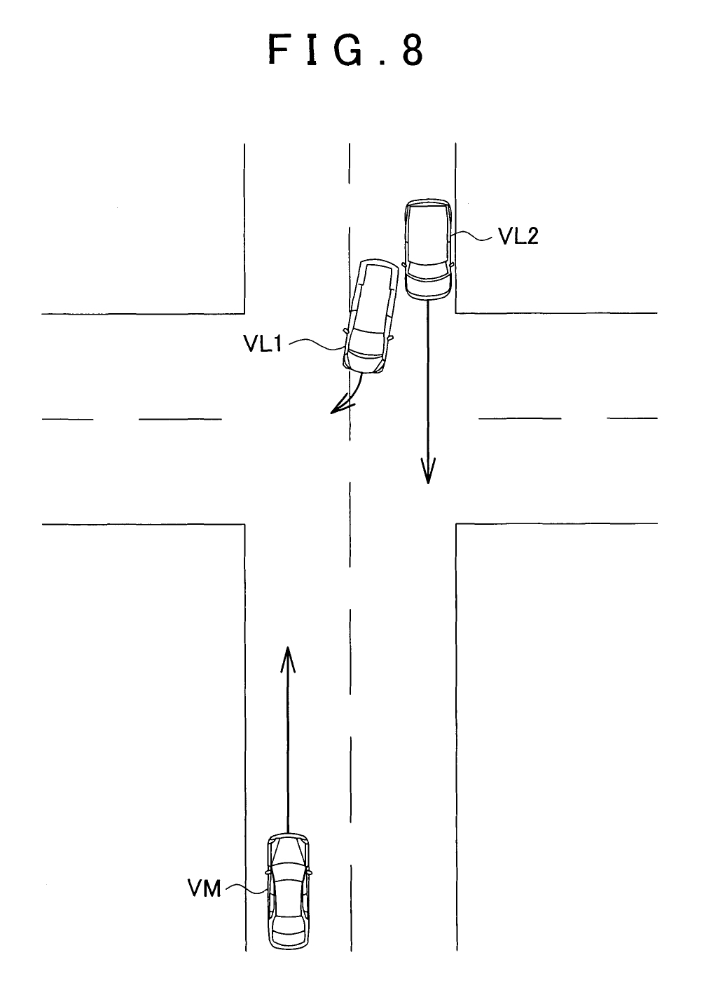

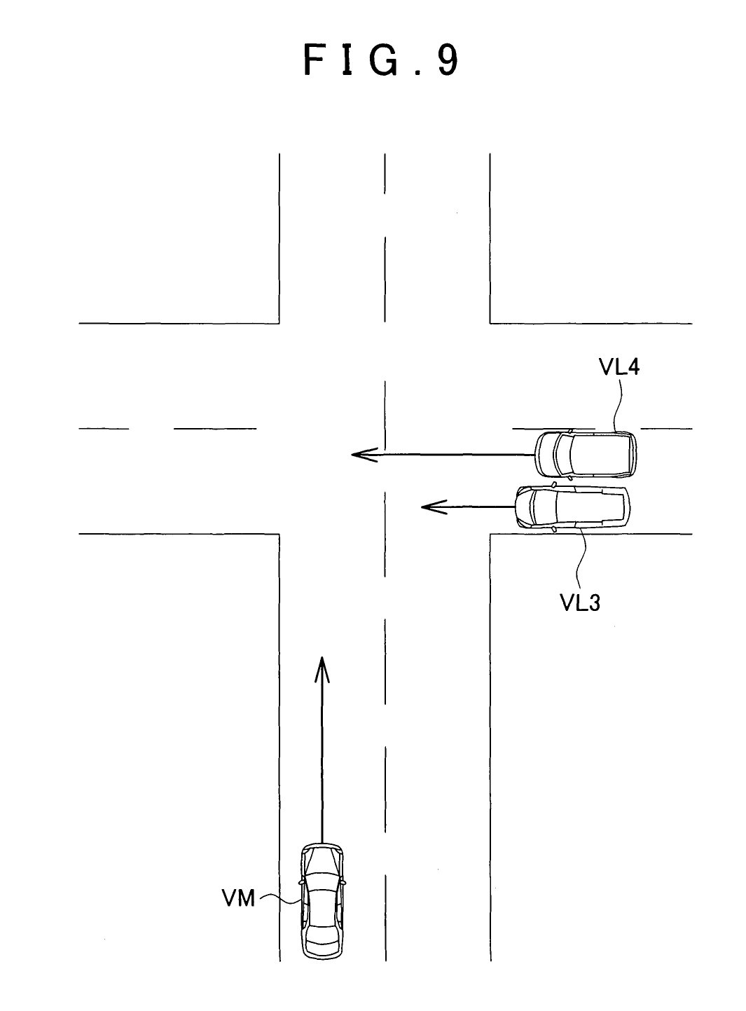

Next, an example of the operation of the target processing portion 13 will be described with reference to FIGS. 4 to 9. FIG. 4 is a flowchart showing an example of a processing performed by the target processing portion 13. FIG. 5 is a diagram showing an example of how to create a target list and permutate the contents thereof. FIG. 6 is a diagram showing an example of a situation of target objects in front of the own vehicle. FIG. 7 is a diagram showing an example of a detection situation of target objects sensed in front of the own vehicle. FIG. 8 is a diagram for explaining a first situation example at an intersection. FIG. 9 is a diagram for explaining a second situation example at an intersection. Respective steps in the flowchart shown in FIG. 4 are carried out through, for example, the execution of a predetermined program by the target processing portion 13. The program for carrying out these processings is stored in advance in, for example, a storage region (e.g., a memory, a hard disc, an optical disc, or the like) provided in the target processing portion 13. This program is executed by the target processing portion 13 when a power supply of the target processing portion 13 is turned on.

In FIG. 4, the target processing portion 13 acquires m pieces of target information from the relative distance/relative speed/relative position calculation portion 12 (step S51), and shifts the processing procedure to the subsequent step. For example, the estimated collision time length calculation portion 131 of the target processing portion 13 updates the target object data Da for the target objects individually, using the data indicating the relative distances of the respective target objects, the relative speeds thereof, and the relative positions thereof (target information), which have been acquired from the relative distance/relative speed/relative position calculation portion 12.

The target processing portion 13 then determines, on the basis of the target information acquired in the aforementioned step S51, whether or not the transmission/reception portion 11 has detected any target object (step S52). When the transmission/reception portion 11 has detected any target object, the target processing portion 13 shifts the processing procedure to the subsequent step S53. On the other hand, when the transmission/reception portion 11 has not detected any target object, the target processing portion 13 returns to the aforementioned step S51 to repeat the processings.

In step S53, the target processing portion 13 calculates the estimated collision time lengths TTC of currently detected target objects, and shifts the processing procedure to the subsequent step. For example, the estimated collision time length calculation portion 131 of the target processing portion 13 calculates the estimated collision time lengths TTC respectively according to the formula TTC=relative distance/relative speed, with reference to the data indicating the relative distances of the respective target objects and the relative speeds thereof, which are stored in the target object data Da.

The target processing portion 13 then creates a target list in which pieces of target information are arranged in the ascending order of the estimated collision time lengths TTC (step S54), and shifts the processing procedure to the subsequent step. For example, the estimated collision time length calculation portion 131 of the target processing portion 13 creates a target list in which pairs of the estimated collision time lengths TIC of the target objects and the relative distances thereof are arranged in the ascending order of the estimated collision time lengths TTC and target numbers T1 to Tm (m=20 in this case) are sequentially assigned thereto, and updates the target list data Db. In the target list used in this embodiment of the invention, the priority rank of target information to be output from the radar device 1 increases as the value of the target number T decreases.

In an example of the target list shown on the left of FIG. 5, five currently detected target objects are arranged in the ascending order of the estimated collision time lengths TTC, and the target numbers T1 to T5 are assigned thereto in this ascending order. In the lines of the target numbers T1 to T5, the relative distances of the target objects as well as the estimated collision time lengths TTC thereof are described respectively. In the case where the number of the currently detected target objects is smaller than the maximum value m (20 in this case), for example, maximum values are described for the data on the estimated collision time lengths TTC and the relative distances for those T of the target numbers T1 to T20 in the target list which are null (in FIG. 5, the data corresponding to those null numbers are shown as blanks).

The target selection portion 132 of the target processing portion 13 then selects the first to n-th data in the target list (i.e., the data with the target numbers T1 to Tn) in a descending order, with reference to the target list data Db (step S55), and shifts the processing procedure to the subsequent step. It should be noted herein that n denotes the number of target objects (the number of transmitted targets) to be included in the pieces of target information output from the radar device 1 to the driver support system ECU 2, and is determined in advance in accordance with a restriction on the communication bus load between the devices (i.e., the communication load of the CAN 1). In the following description, an example in which the number n of transmitted targets is set equal to 4 will be used so as to make the description concrete.

The target processing portion 13 then determines whether or not any one of the (n+1)th to last target objects in the target list is closer to the own vehicle than the n-th target object (step S56). More specifically, with reference to the relative distance of the target number Tn described in the target list, the target selection portion 132 of the target processing portion 13 determines whether or not any target object having a shorter relative distance than the relative distance is described in the lines of the target numbers Tn+1 to Tm.

For example, in the example of the target list shown on the left of FIG. 5, in the case where the number n of transmitted targets=4, the relative distance of the target number Tn (i.e., T4) is 45.1. On the other hand, since the relative distance of the target number Tn+1 (i.e., T5) is 38.0, the target selection portion 132 determines that relative distances shorter than that of the target number Tn are described in the lines of the target numbers Tn+1 to Tm respectively (i.e., makes a determination of Yes in the aforementioned step S56). When a determination of Yes is made in the aforementioned step S56, the target selection portion 132 shifts the processing procedure to the subsequent step S57. On the other hand, when a determination of No is made in the aforementioned step S56, the target selection portion 132 shifts the processing procedure to the subsequent step S58.

In step S57, the target selection portion 132 grades up to the n-th rank in the target list that one of the (n+1)th to last target objects in the target list which is closest to the own vehicle, and thereby permutates the contents of the target list. More specifically, with reference to the relative distances of the target numbers Tn+1 to Tm described in the target list, the target selection portion 132 carries out permutation by setting the data with the target numbers Tn+1 to Tm in the lines of which the shortest relative distance is described as the data with the target number Tn. The target selection portion 132 then shifts the processing procedure to the subsequent step S58.

For example, in the example of the target list shown in FIG. 5, in the case where the number n of transmitted targets=4, the relative distance of the target number T5 is the shortest among the target numbers Tn+1 to Tm. Accordingly, the target selection portion 132 moves the data on the target number T5 to the line of the target number Tn (i.e., T4) to thereby permutate the contents of the target list (the target list shown on the right of FIG. 7). Thus, the data described in the line of the target number T4 before permutation grade down through permutation and move to the line of the target number T5. That is, the data in the line of the target number T4 are replaced with the data in the line of the target number T5 through the processing of the aforementioned step S57.

In step S58, the target selection portion 132 outputs to the driver support system ECU 2 pieces of target information as output subjects corresponding to the first to n-th data in the priority order in the target list, and shifts the processing procedure to the subsequent step. For example, the target selection portion 132 of the target processing portion 13 writes into the output data Dc as output subjects pieces of target information (e.g., relative positions and relative speeds) on the target objects with the target numbers T1 to Tn described in the target list. The target information output portion 133 of the target processing portion 13 outputs to the driver support system ECU 2 the pieces of target information written into the output data Dc, sequentially for the target objects individually. Thus, the pieces of target information on the first to n-th target objects described in the target list are transmitted from the radar device 1 to the driver support system ECU 2 via the CAN 2.

The target processing portion 13 then determines whether or not the processing procedure should be terminated (step S59). For example, in accordance with a case where the driver performs an operation of terminating the aforementioned processing procedure, the target processing portion 13 terminates the processing procedure. When the processing procedure should be continued, the target processing portion 13 then returns to the aforementioned step S51 to repeat the processings. On the other hand, when the processing procedure should be terminated, the target processing portion 13 terminates the processing procedure according to this flowchart.

As described above, the obstacle detection device according to this embodiment of the invention narrows down the output subjects whose pieces of target information are to be output, in the ascending order of the estimated collision time lengths TTC, which are calculated from the relative speeds and relative distances of the target objects diagonally approaching the own vehicle from outside the own lane or the like, thereby making it possible to achieve reductions in calculation load and communication load in the entire system. Further, the obstacle detection device can select targets whose risks of collisions with the own vehicle can be appropriately determined. That is, the obstacle detection device can achieve a sufficient effect even by simply selecting the target objects subjected to the priority processing in the ascending order of the estimated collision time lengths TTC. In addition, however, even in the case where the required pieces of target information on the target objects are excluded from output subjects when the target objects are narrowed down only in the order of the estimated collision time lengths TTC, the obstacle detection device can also integrate the target objects into the output subjects. A concrete example in which the output subjects are replaced will be described hereinafter.

First of all, an example in which the output subjects whose pieces of information are output from the radar device 1 to the driver support system ECU 2 are changed through the processing performed by the aforementioned target processing portion 13 will be described with reference to FIGS. 6 and 7.

For example, it is assumed that five target objects with the target numbers T1 to T5 as shown in FIGS. 6 and 7 exist in front of the own vehicle. The estimated collision time lengths TTC of the respective target objects are as follows. The estimated collision time length TTC of the target object with the target number T1 is 0.81. The estimated collision time length TTC of the target object with the target number T2 is 0.83. The estimated collision time length TTC of the target object with the target number T3 is 1.74. The estimated collision time length TTC of the target object with the target number T4 is 2.94. The estimated collision time length TTC of the target object with the target number T5 is 3.37. That is, the target numbers T1 to T5 are assigned to the five target objects respectively in the ascending order of the estimated collision time lengths TTC. It is then assumed that the number of transmitted targets is set equal to 4.

According to the aforementioned processing operation of selecting the targets, the target number T4 is the n-th target object in the target list before permutation. It is to be noted herein that the target object with the target number T4 is located farther than the target object with the target number T5, but that because of a relatively high running speed of the target object with the target number T4, the estimated collision time length thereof is set shorter than that of the target object with the target number T5. Accordingly, through the permutation processing of the aforementioned step S57, the target number T4 and the target number T5 are replaced with each other. That is, the target object with the target number T5 grades up to the output subjects, and the target object with the target number T4 grades down from the output subjects. A case where a remarkable effect can be achieved through this replacement processing of the output subjects will be described hereinafter.

As shown in FIG. 8, it is assumed that on an oncoming lane of an intersection located in front of a running own vehicle VM, there is an oncoming right-turning vehicle VL1 turning right at the intersection. This oncoming right-turning vehicle VL1 has a very high risk of a collision with the own vehicle VM at the aforementioned intersection, and is therefore a target object that needs to be included in the pieces of target information output from the radar device 1 to the driver support system ECU 2. However, when an oncoming straight-running vehicle VL2 runs straight at high speed beside the oncoming right-turning vehicle VL1, the estimated collision time length TTC of the oncoming straight-running vehicle VL2 is shorter than the estimated collision time length TTC of the oncoming right-turning vehicle VL1. Therefore, the narrowing-down priority rank of the oncoming right-turning vehicle VL1 is considered to lower. Accordingly, the oncoming right-turning vehicle VL1 is considered to be excluded from the output subjects of the radar device 1.

However, in the case where the oncoming straight-running vehicle VL2 is the n-th target object in the target list before permutation, since the oncoming right-turning vehicle VL1 is located closer to the own vehicle VM than the oncoming straight-running vehicle VL2, the oncoming right-turning vehicle VL1 and the oncoming straight-running vehicle VL2 are replaced with each other through the permutation processing of the aforementioned step S57. That is, the oncoming right-turning vehicle VL1 grades up to the output subjects, and the oncoming straight-running vehicle VL2 grades down from the output subjects. Therefore, the pieces of target information on the oncoming right-turning vehicle VL1 desired to be included in the target information can be output from the radar device 1 to the driver support system ECU 2.

As another scene example, as shown in FIG. 9, it is assumed that on a road crossing an intersection located in front of the running own vehicle VM, there is an entering vehicle VD that is about to enter the intersection. This entering vehicle VL3 has a very high risk of a collision with the own vehicle VM at the aforementioned intersection, and is therefore a target object that needs to be included in the pieces of target information output from the radar device 1 to the driver support system ECU 2. However, in the case where an entering vehicle VL4 runs at high speed beside the entering vehicle VL3 and is about to enter the aforementioned intersection on the road where the entering vehicle VL3 is located, the estimated collision time length TTC of the entering vehicle VL4 is shorter than the estimated collision time length TTC of the entering vehicle VL3. Therefore, the narrowing-down priority rank of the entering vehicle VL3 is considered to lower. Accordingly, the entering vehicle VL3 is considered to be excluded from the output subjects of the radar device 1.

However, in the case where the entering vehicle VL4 is the n-th target object in the target list before permutation, since the entering vehicle VL3 is located closer to the own vehicle VM than the entering vehicle VL4, the entering vehicle VL3 and the entering vehicle VL4 are replaced with each other through the permutation processing of the aforementioned step S57. That is, the entering vehicle VL3 grades up to the output subjects, and the entering vehicle VL4 grades down from the output subjects. Therefore, the pieces of target information on the entering vehicle VL3 desired to be included in the target information can be output from the radar device 1 to the driver support system ECU 2.

In the aforementioned target selection processing of the target processing portion 13, when any of the relative distances corresponding to the target numbers Tn+1 to Tm described in the target list is shorter than the relative distance corresponding to the target number Tn, the processing of replacing the data on the target number T having the shorter relative distance with the data on the target number Tn is performed (see step S57). However, the data on the other target numbers T1 to Tn−1 described in the target list may also be replaced with any of the data on the target numbers Tn+1 to Tm.

For example, after the processing of replacing the target number Tn is terminated, a similar processing may be performed regarding the data on the target number Tn−1 and the target number Tn−2 as replacement subjects. More specifically, when any one of the relative distances corresponding to the target numbers Tn+1 to Tm described in the target list is shorter than the relative distance corresponding to the target number Tn−1 after the processing on the target number Tn is terminated, the processing of replacing the data on the target number T having the shorter relative distance with the data on the target number Tn−1 is performed. Furthermore, in the case of performing the replacement processing as to the target number Tn−2 as well, when any one of the relative distances corresponding to the target numbers Tn+1 to Tm described in the target list is shorter than the relative distance corresponding to the target number Tn−2 after the processing regarding the target numbers Tn and Tn−1 is terminated, the processing of replacing the data on the target number T having the shorter relative distance with the data on the target number Tn−2 is performed.

Further, the aforementioned processing of the target processing portion 13 is typically performed in each of the radar devices constituting the radar device 1 mounted on the vehicle. For example, as described using FIG. 1, in the case where the vehicle is mounted with the radar device 1L whose sensing direction is directed leftward and forward of the vehicle and the radar device 1R whose sensing direction is directed rightward and forward of the vehicle, the aforementioned processing of the target processing portion 13 is performed in each of the radar device 1L and the radar device 1R.

Further, in the driver support system ECU 2, the aforementioned processing of the target processing portion 13 may be performed. For example, in the case where the vehicle is mounted with a plurality of radar devices, all the pieces of target information output from the radar devices respectively are gathered into the driver support system ECU 2. Accordingly, the driver support system ECU 2 deals with many gathered pieces of target information, but can use the aforementioned processing of the target processing portion 13 in narrowing down those pieces of target information through the processing of assigning priority ranks thereto respectively. Thus, the driver support system ECU 2 can select, while reducing the processing load thereof, targets whose risks of collisions with the own vehicle can be appropriately determined. In this case, the plurality of the radar devices are equivalent to an example of the plurality of the detection devices of the invention, and the driver support system ECU 2 is equivalent to an example of the object selection device of the invention.

Further, in the foregoing description of the embodiment of the invention, the example in which pairs of target number, estimated collision time length, and relative distance are described in the target list stored as the target list data Db is used. However, other items may be added to the description of the target list. For example, the relative distances of the target objects and the relative speeds thereof, which have been calculated by the relative distance/relative speed/relative position calculation portion 12, may be additionally described in the target list.

Further, in the foregoing description, the example in which the predetermined program is executed to perform the processing of the target processing portion 13 is used. However, it is also appropriate to combine an integrated circuit capable of performing the processing.

Further, the aforementioned processing sequence of the target processing portion 13, the values such as the maximum number m of the target objects and the number n of the transmitted targets, and the like are no more than examples. Other sequences and other values may also be adopted.

Further, the program executed by the target processing portion 13 may not necessarily be stored in advance in the storage region provided in the target processing portion 13. Instead, this program may be supplied to the target processing portion 13 through an external storage medium, or be supplied to the target processing portion 13 through a wired or wireless communication line.

Although the invention has been described above in detail, the foregoing description is no more than an exemplification of the invention in all respects, and is not intended to limit the scope thereof. Needless to say, the invention can be subjected to various improvements and modifications without departing from the scope thereof.

The obstacle detection device and the obstacle detection system according to the invention can achieve a reduction in calculation load or communication load through the selection of targets whose risks of collisions with an own vehicle can be appropriately determined, and are useful for a sensing device, a sensing system, and the like that sense the surroundings of the own vehicle.

1. An obstacle detection device comprising:
a detection portion that detects objects relatively approaching a vehicle;
a relative distance/relative speed calculation portion that calculates relative distances of the objects detected by the detection portion with respect to the vehicle and relative speeds of the objects detected by the detection portion with respect to the vehicle;
an estimated collision time length calculation portion that calculates estimated collision time lengths to collisions of the objects with the vehicle, using the calculated relative distances of the objects and the calculated relative speeds of the objects respectively;
an object selection portion that selects a predetermined number of the detected objects that are arranged in an ascending order of the estimated collision time lengths as selected objects;
an information output portion that outputs pieces of detected information on the selected objects; and
a selected object change portion that replaces, when the object having a shorter relative distance than that one of the objects selected by the object selection portion which has a predetermined rank in an ascending order of the estimated collision time lengths belongs to the detected objects except the selected objects, the object having the shorter relative distance and one of the objects selected by the object selection portion with each other to change the selected objects.

2. The obstacle detection device according to claim 1, wherein the object replaced with the object having the shorter relative distance by the selected object change portion is that one of the objects selected by the object selection portion which has a predetermined rank.

3. The obstacle detection device according to claim 1, wherein the object replaced with the object having the shorter relative distance by the selected object change portion is that one of the objects selected by the object selection portion which has a longest estimated collision time length.

4. The obstacle detection device according to claim 3, wherein the selected object change portion replaces, when the object having the shorter relative distance is shorter in relative distance than that one of the objects selected by the object selection portion which has the longest estimated collision time length, the object having the shorter relative distance and that one of the objects selected by the object selection portion which has the longest estimated collision time length with each other to change the selected objects.

5. The obstacle detection device according to claim 4, wherein the selected object change portion further replaces, when the object having a shorter relative distance than that one of the objects selected by the object selection portion which has the second longest estimated collision time length belongs to the detected objects except the selected objects and the replaced object, the object having the shorter relative distance and that one of the objects selected by the object selection portion which has the second longest estimated collision time length with each other to change the selected objects.

6. The obstacle detection device according to claim 1, wherein the object selection portion generates a list in which pieces of information on the objects are described in arrangement in the ascending order of the estimated collision time lengths,
the selected object change portion replaces description ranks of the pieces of information on the objects in the list to change the selected objects, and
the information output portion outputs the pieces of information on a predetermined number of the objects described in the list in a descending order from a highest rank.

7. The obstacle detection device according to claim 1, wherein the number of the objects selected by the object selection portion is set on a basis of a communication bus load output from the information output portion to another device.

8. The obstacle detection device according to claim 1, wherein the estimated collision time length calculation portion divides the relative distances of the objects by the relative speeds thereof to calculate the estimated collision time lengths of the objects respectively.

9. The obstacle detection device according to claim 1, wherein the objects detected by the detection portion are objects relatively approaching the vehicle diagonally.

10. An obstacle detection system comprising:
a plurality of the detection devices that detect objects relatively approaching a vehicle respectively;
an object selection device that selects a predetermined number of the objects from the objects detected by the plurality of the detection devices respectively,
wherein
the plurality of the detection devices calculate at least relative distances of the detected objects with respect to the vehicle and relative speeds of the detected objects with respect to the vehicle and output the relative distances and the relative speeds to the object selection device,
the object selection device includes an acquisition portion that acquires the relative distances of the objects output from the plurality of the detection devices respectively and the relative speeds of the objects output from the plurality of the detection devices respectively, an estimated collision time length calculation portion that calculates estimated collision time lengths to collisions of the objects with the vehicle respectively, using the relative distances of the objects acquired by the acquisition portion and the relative speeds of the objects acquired by the acquisition portion, an object selection portion that selects the predetermined number of the objects in an ascending order of the estimated collision time lengths, and
a selected object change portion that replaces, when the object having a shorter relative distance than that one of the objects selected by the object selection portion which has a predetermined rank in an ascending order of the estimated collision time lengths belongs to the detected objects except the selected objects, the object having the shorter relative distance and one of the objects selected by the object selection portion with each other to change the selected objects.

11. The obstacle detection system according to claim 10, wherein at least one of the plurality of the detection devices detects objects approaching the vehicle from spots diagonally forward and rightward thereof, and at least another one of the plurality of the detection devices detects objects approaching the vehicle from spots diagonally forward and leftward thereof.

12. An obstacle detection method comprising:
detecting objects relatively approaching a vehicle;
calculating relative distances of the detected objects with respect to the vehicle and relative speeds of the detected objects with respect to the vehicle;
calculating estimated collision time lengths to collisions of the objects with the vehicle, using the calculated relative distances of the objects and the calculated relative speeds of the objects respectively;
selecting a predetermined number of the detected objects that are arranged in an ascending order of the estimated collision time lengths;
outputting pieces of detected information on the selected objects; and
outputting, when the object having a shorter relative distance than that one of the predetermined number of the objects which has a predetermined rank in an ascending order of the estimated collision time lengths belongs to the detected objects except the predetermined number of the objects, detected information on the object having the shorter relative distance instead of detected information on the object having the predetermined rank.
